(19) United States
(12) Patent Application Publication
(10) Pub. No.: US 2021/0242760 A1
(43) Pub. Date: Aug. 5, 2021

(54) Electric Insulation System of an Electric Motor, and Associated Manufacturing Process

(71) Applicant: Siemens Aktiengesellschaft, München (DE)

(72) Inventors: Tobias Katzenberger, Bad Königshofen STT Untereßfeld (DE); Bastian Plochmann, Neustadt an der Aisch (DE)

(73) Assignee: Siemens Aktiengesellschaft, München (DE)

(21) Appl. No.: 17/052,786

(22) PCT Filed: May 3, 2019
(86) PCT No.: PCT/EP2019/061435

§ 371 Date: Nov. 3, 2020

(30) Foreign Application Priority Data
May 4, 2018 (EP) 18170759.7

(51) Int. Cl. H02K 15/12; H02K 3/30; H02K 3/34; H02K 15/10; B29C 70/72

(52) U.S. Cl. CPC H02K 15/12; H02K 3/30; B29L 2031/7498; H02K 15/105; B29C 70/72; H02K 3/34

(57) ABSTRACT

Various embodiments of the teachings herein include an electric insulation system of an electric motor comprising a conductor with a wire winding in a slot of a laminated core of a stator of the electric motor. Wires in the conductor are potted by impregnating resin on and in a carrier. The carrier is loaded with impregnating resin and is arranged between the winding wires in the conductor. Cavities of the conductor are filled with the impregnating resin. The impregnating resin provides potting for the cavities in the conductor of the laminated core.

### CROSS-REFERENCE TO RELATED APPLICATIONS

This application is a U.S. National Stage Application of International Application No. PCT/EP2019/061435 filed May 3, 2019, which designates the United States of America, and claims priority to EP Application No. 18170759.7 filed May 4, 2018, the contents of which are hereby incorporated by reference in their entirety.

### TECHNICAL FIELD

The present disclosure relates to electric motors. Various embodiments include electric insulation systems for electric motors and/or manufacturing processes for electric insulation systems of an electric motor.

### BACKGROUND

Laminated cores of electric motors typically comprise slots with a wire winding, generally a copper wire winding, wherein the wire is electrically insulated by means of wire enamel. There are various possibilities of manufacturing electric motors depending on the size and performance classes. At the order of size of an axle height of 63 mm to 450 mm and corresponding to the outputs of 150 W to 1.6 MW, typically the “stator”, i.e. the laminated core, is provided with pre-wound wire windings. Said windings are introduced here mechanically into the stator slots and subsequently connected.

The electric insulation of the individual wires from one another and in relation to the laminated core, which is at ground potential, is provided by surface insulation materials, such as paper, and the wire enamel of the individual winding wires. Due to the geometrical requirements of the slots, such as the tooth serving for forming magnetic field lines which are closed as far as possible, a maximum slot filling of 85% by vol with copper wire, including wire enamel, is possible since otherwise, for example, the drawing-in forces would become too great and therefore the surface insulation and/or the wire enamel could be damaged, for example, by means of scratches, tears and/or by means of expansion. As a result, at least 15% by vol of free volume remain in the slots of the laminated core. Part of the volume is exposed because the winding does not precisely fill the corners of the slot, but existing cavities within the winding are filled as completely as possible in the impregnating process with impregnating resin.

Unfortunately, it has been shown that there are considerable gaps here because, when the stator is extracted from the dipping bath, the impregnating resin is frequently still so fluid that the cavities even within the conductor, i.e. the wire winding, are not sufficiently filled in this case. For this purpose, generally in a dipping process, one or more stators are dipped slowly into a liquid impregnating resin basin so that the liquid impregnating resin can flow into the cavities between the individual wires, the wire winding and the laminated core and can fill said cavities. Subsequently, the stators impregnated in this manner are cured by the action of temperature and/or UV radiation for a certain period of time. As a result, the liquid and/or gelled impregnating resin that fills the cavities of the winding in the dipping bath as far as possible becomes the finished potting compound, for example in the form of a completely cured thermosetting polymer as the potting compound.

The quality of the impregnation is ultimately defined by as high a degree of filling of the cavities as possible and as low a residual enthalpy of the impregnating resin as possible. Optimum features here are firstly cavities of the stator that are completely filled with impregnating resin and secondly complete crosslinking of the impregnating resin. A disadvantage of impregnating processes in general and of the dipping bath impregnation in particular is that, for the impregnation of different types of stator, the rheology and the chemical reactivity of the impregnating resin in the bath has to be adjusted to the respective type of stator so that complete filling of the cavities is also ensured. Different types of stator differ in the impregnating behavior—not only in the dipping bath—in particular because of different temperature gradients, heat capacities and different flow paths.

A higher or lower viscosity is required, depending on the type of stator, so that complete filling of the cavities by the impregnating resin and at the same time rapid gelling take place. However, this subsequently makes it difficult for the impregnating resin to flow off when the stator is removed from the impregnating station, for example the dipping bath. So that different types of stator can be economically impregnated in a common impregnating station, the rheology, viscosity and/or the chemical composition of the dipping bath is adjusted to a mean value without optimization in respect of a type of stator. An impregnating resin suitable for this purpose is technically highly developed in respect of the rheology, thixotropy and the chemical reactivity with regard to gelling time and/or residual enthalpy, and is therefore correspondingly expensive. Although impregnating resins which are also cheaper because of their mechanical, electric and chemical properties would be sufficient for use in the stator, they are not suitable for a dipping bath in which different types of stator are impregnated.

A further disadvantage of the conventional dipping baths is also that the thermal preliminary crosslinking, which is also called gelling, in the winding has to be successful so that the liquid impregnating resin remains in the winding when the stator is removed from the dipping bath, with this requirement being contradictory to the requirement that excessive impregnating resin on the outer wall of the stator should flow off again as completely as possible when the stator is removed from the dipping bath. However, the liquid impregnating resin that was in contact with a hot stator and drips back into the dipping bath contaminates the dipping bath and causes a deterioration in the quality of the impregnating resin in the bath for subsequent impregnations.

### SUMMARY

The teachings of the present disclosure include targeted filling of the wire windings of a conductor with impregnating resin. The teachings herein may be used to increase the homogeneity of the impregnating resin filling of the cavities within the surface insulation, i.e., for example, the paper winding which surrounds the conductor, i.e. the wire winding. As an example, some embodiments include an electric insulation system EIS of an electric motor, comprising at least one conductor having a wire winding in a slot of a laminated core of a stator, characterized in that the wires in the conductor are potted by impregnating resin on and in at least one carrier, which is loaded with impregnating resin and is arranged between the winding wires in the conductor, in such a manner that the cavities of the conductor are filled with the impregnating resin from the carrier, wherein the content of impregnating resin arising by introduction of the carriers into the conductor suffices for potting the cavities in the conductor of the laminated core.

In some embodiments, the carrier comprises prepreg fibers.

In some embodiments, the prepreg fibers comprise intermingled fibrils.

In some embodiments, the prepreg fibers comprise plastic fibers. In some embodiments, the prepreg fibers comprise glass fibers.

In some embodiments, the prepreg fibers comprise felts.

In some embodiments, the prepreg fibers are substantially identical.

In some embodiments, the prepreg fibers comprise fiber mixtures of fibers of different lengths.

In some embodiments, the prepreg fibers comprise fiber mixtures of fibers of different materials.

In some embodiments, up to 35% by vol, in particular up to 26% by vol of impregnating resin and carrier are present in the conductor.

In some embodiments, in volume fractions of prepreg carrier to winding wire at maximum 5% by vol of prepreg fiber to 1% by vol of winding wire are present in the conductor.

As another example, some embodiments include an electric insulation system EIS of an electric motor having a wire winding as conductor in the slots of the laminated core, in which the wire winding and at least one carrier in the conductor are embedded in a potting compound, wherein the potting compound in the conductor is distributed uniformly around the wires and the at least one carrier because the impregnating resin for this purpose is not guided into the conductor from the outside, but rather by means of the carriers which, for this purpose, are loaded with impregnating resin in the B state and which remain with the winding wires in the winding.

As another example, some embodiments include a process for manufacturing an electric insulation system EIS of an electric motor, comprising the following method steps: winding a conductor from winding wire and impregnating resin carriers, drawing the conductor formed in this manner into the slots of a laminated core of a stator of the electric motor, and curing the impregnated winding wire/carrier insulation.

In some embodiments, between the drawing-in of the conductor and the curing, there is an intermediate step for heating up the stator in the hot air furnace and/or by means of current heating to a temperature at which the prepreg impregnating resin in and on the impregnating resin carrier melts and is uniformly distributed into the adjacent intermediate spaces of the individual winding wires in the slot.

In some embodiments, the impregnating resin is uniformly distributed between the winding wires of the conductor and within the slot at least partially via capillary forces.

### BRIEF DESCRIPTION OF THE DRAWINGS

FIG. 1 shows the prior art with EIS which can be manufactured by dipping conductors in impregnating resin baths.

FIG. 2 shows a conductor incorporating teachings of the present disclosure in cross section.

### DETAILED DESCRIPTION

In some embodiments, there is an electric insulation system EIS of an electric motor, comprising at least one conductor having a wire winding in a slot of a laminated core of a stator, characterized in that the wires in the conductor are potted by impregnating resin on and in at least one carrier, which is loaded with impregnating resin and is arranged between the winding wires in the conductor, in such a manner that the cavities of the conductor are filled with the impregnating resin of the carrier, wherein the content of impregnating resin in the carrier suffices for potting the wires in the conductor of the laminated core.

In some embodiments, there is an electric insulation system EIS of an electric motor having a wire winding as conductor in the slots of a laminated core, in which the wire winding and at least one carrier in the conductor are embedded in a potting compound, wherein the potting compound in the conductor is distributed uniformly around the wires and the at least one carrier because the impregnating resin for this purpose is not guided into the conductor from the outside, but rather by means of the carriers which, for this purpose, are loaded with impregnating resin in the B state and which remain with the winding wires in the winding.

“Distributed uniformly” is in contrast here to the distribution of impregnating resin in the conductor, the distribution resulting from, for example, dipping bath impregnation, in which the resin still in liquid form has at least partially run out of the conductor again. The points in the conductor that are the first, according to the prior art, to leave the dipping bath generally have more unfilled cavities than the points in the conductor remaining for a longer period in the dipping bath during the removal. At any rate, the starting point is that, in the dipping bath impregnation, there is no uniform distribution of the potting compound around the wires of a winding.

In some embodiments, there is a process for manufacturing an electric insulation system EIS of an electric motor, comprising the following method steps:
winding a conductor from winding wire and impregnating resin carriers,
drawing the conductor formed in this manner into the slots of a laminated core of a stator of the electric motor, and
curing the impregnated winding wire/carrier insulation.

In some embodiments, the complicated and unsatisfactory impregnating dipping process during the manufacturing of an electric winding wire insulation system EIS of an electric motor can be spared by introducing a sufficient quantity of resin as a prepreg on and/or in a carrier, such as, for example, a fiber. Prepreg fibers, by themselves or in combination with further carriers, may be used here as the “carrier” or “impregnating resin carrier”. Further carriers within this context may be, for example, sponges and/or foams.

A “conductor” refers herein to a winding of wires which are wound together in surface insulation material, such as, for example, paper, and form a bundle of winding wires which is drawn into a slot in a laminated core. For example, up to 200 wires within the wire winding wrapped by surface insulation material can be present per conductor.

If a conductor incorporating teachings of the present disclosure is cut open in cross section, the circle showing the diameters of the wires reveal that the diameters in the best case are arranged according to the pattern of “densest” sphere packing in the crystal. In the cross-sectional image, there are then between the individual wires forming the large circles, for example, further individual points facing a carrier, such as a fiber. This is true if the cross section of the prepreg fiber is small in comparison to the cross section of the wire.

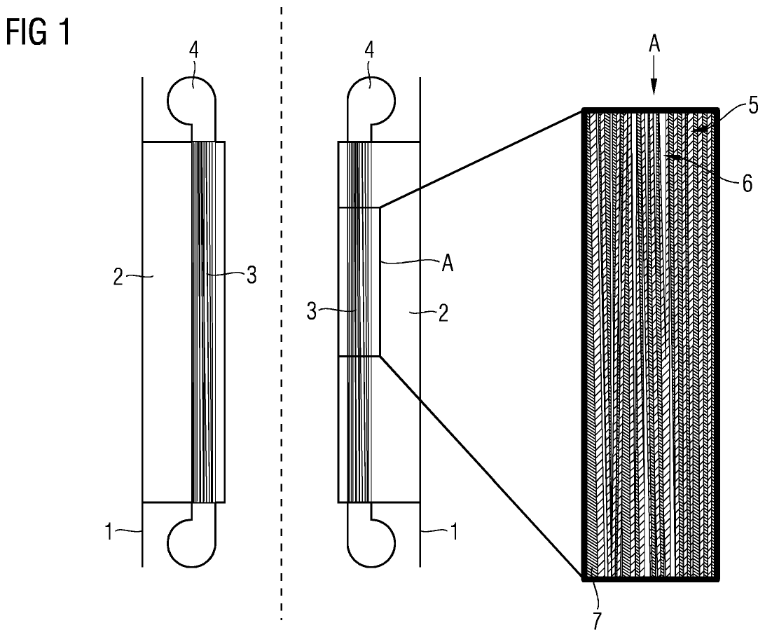

Generally, however, the wire winding is not filled with wires arranged completely parallel, and therefore generally what is referred to as a “wild winding”, as shown in FIG. 1, may be present. Analogously to the space filling of the densest sphere packing, which amounts to 74%, it is therefore assumed that the remaining at least 26% by vol of cavity in the conductor can be filled with carriers, for example fibers, braids and/or fiber bundles.

In some embodiments, the systems and/or methods are used to fill as much of said cavity as possible with carrier, the cavity in any case not being used by the wires for dimensional reasons. Assuming that, accordingly, ideally 26% by vol, i.e. by way of estimation in an actual case, up to 35% by vol or more, depending on the quality of the winding, are not occupied by wire in the conductor, 35% by vol remain in the conductor for filing with impregnating resin. By means of the carrier, a quantity of impregnating resin sufficient for this purpose is introduced into the winding, the impregnating resin ideally filling up to 100%, e.g. up to 80% and/or between 30 and 80% of said abovementioned at least free 35% by vol in the conductor by impregnating resin or potting compound and carrier.

In some embodiments, the carrier, i.e., for example, the prepreg fibers, are wound simultaneously with the winding of the wires, in particular the copper wires, and are thus present in the winding and in the finished electric motor between the winding wires in the conductor with said winding wires. In principle, the number of prepreg fiber windings, if the diameter thereof is comparable to the diameter of the wire, in relation to the winding wire windings is selected to be as small as necessary so as not to waste any space in the slot that would be fillable with winding wire.

The number of prepreg fiber windings and the size of the prepreg fiber volumes is correspondingly selected in the voltage field to be between being sufficiently high such that the conductor is potted as completely as possible after the curing and as low as possible so that the volumetric degree of filling in the slot with conduction material, preferably with copper wire, is thereby not impaired. By the introduction of the impregnating resin on a carrier into the conductor, the quantity and type of impregnating resin can be very simply varied within wide ranges, depending on the type of motor, during the winding by adding/reducing the co-wound prepreg fibers.

This demonstrates the great flexibility of manufacturing the electric insulation system EIS of an electric motor incorporating teachings of the present disclosure. For example, long and/or endless fibers are present in the conductor having an approximately identical diameter and with a winding wire in a ratio of 1 fiber to 7 wires, in some embodiments, 1 fiber to 5 wires and/or 1 fiber to 3 wires in the winding. The ratio of prepreg fibers to winding wires can also be in favor of the fibers, for example in the range of 5 fibers per wire to one fiber per wire, i.e. a ratio of 1:1 in the winding. The respective portions are based, for example, on the absorbency of the fiber, i.e. the resin content per volumetric portion of fiber, the diameter of the fiber, etc.

In some embodiments, the volume of the fiber is increased during the impregnation with resin by absorbing the resin and is corresponding reduced again during the formation of the potting compound.

In some embodiments, the fibers, in addition to being bundled or alternatively thereto, are laid, drawn and/or spun around the winding wires.

In some embodiments, the fibers comprise, for example, thin yarns, in particular “atomized” fibers, such as, for example, floss, and/or linear fibers in which the fibrils are present in untwisted form. The fibers may have the form of ceramic fibers, plastic fibers, glass fibers, felts, carbon fibers, polyethylene fibers, PET fibers, polyethylene imide fibers, polyamide imide fibers and/or cotton fibers, and in the form of any mixture of the abovementioned fibers in fiber bundles, fiber braids or the like. Short fibers or woven fabrics may also expediently be used; in this respect, there are no limits on the selection of the carrier.

The fiber and/or the material of the carrier is selected in such a manner that the tensile strength is sufficient for the winding process. The fiber may be selected in terms of the material, the construction and/or the surface composition in such a manner that high wettability and/or impregnability with the respective impregnating resin is provided along with sufficient tensile strength and naturally electric insulation in the carrier.

In some embodiments, to manufacture the prepreg-preimpregnated fibers, the latter are impregnated with a resin which is B-state capable. In the present case, the “B-state of a resin” refers to a resin, for example a thermosetting polymer, which, when partially gelled—in particular at room temperature—may be slightly sticky but is not yet cured through. This state is also referred to as the preliminary product of the thermosetting polymer as a prepolymer. This state of the prepolymer is provided if the impregnating resin is crosslinked only in small parts, but in terms of surface obtains a certain stability, such that, although it is not solid and crosslinked, it is also no longer fluid. In the B-state, a thermosetting polymer can be once again melted and liquefied without being destroyed.

The impregnating resin of the prepreg fiber is present in the B-state, that is to say that, under some circumstances, it is slightly sticky in terms of surface. Subsequently, during the curing process, which generally takes place by increasing the temperature and/or by irradiation, said impregnating resin in the B-state of the prepreg fibers melts, runs within the conductor and around the winding wires within the slot and chemically cures through until a potting compound is formed. A potting compound is made of synthetic resin and refers to the thermosetting polymer which has completely cured through and is no longer deformable and instead can only be processed by machining.

In some embodiments, the conductor, comprising winding wire and fibers, is present in the finished electric motor in such a potting compound.

In some embodiments, the carriers used in the manufacturing of the conductor, i.e. the winding of the conductive winding wires, which are insulated with wire enamel, are prepreg carriers, i.e., for example, prepreg fibers. The fiber, for manufacturing the prepreg fiber, can be preimpregnated, for example, by dipping impregnation of the fibers. Fibers are drawn here through a dipping bath which contains the impregnating resin, for example diluted with a solvent. The fiber is drawn at a predetermined speed through the dipping bath, wherein the fiber firstly absorbs impregnating resin on the surface and, depending on the absorbency of the fiber, also inside the fiber, for example in open pores and/or in braiding or felting cavities. After the end of the dipping bath, the preimpregnated fiber is dried and is thus freed from solvent. The B-state of the impregnating resin in and on the fiber is also produced. It is possible for the fiber which is wetted with impregnating resin in the B-state to be slightly sticky on the surface.

The fiber impregnated and dried in this manner is then called a “prepreg fiber”. The carrier filled with impregnating resin, and also the prepreg fiber are also included in the term “semi-finished product”. In contrast thereto, the carrier and/or the fiber which has only a small residual content of impregnating resin, if any at all, is simply referred to as “fiber”.

Atomized fibers, in which the fibrils are not present linearly, but rather in intermingled form and/or are connected similarly to felt and are sometimes also adhesively bonded at certain points, exhibit a higher absorption of impregnating resin than fibers composed of fibers arranged linearly, parallel or virtually linearly and parallel. A “fibril” refers here to a small thin fiber which, under some circumstances, cannot be seen at all with the naked eye. A plurality of fibrils, i.e., for example, hundreds thereof, form a fiber, such as, for example, an endless fiber or a long fiber, for manufacturing a prepreg fiber.

The carriers, for example at least partially comprising prepreg fibers, are introduced in the winding process therewith into the winding and can thus be laid into the geometrical intermediate spaces of the winding wires insulated with wire enamel, e.g. copper wires. The product of the winding is the conductor which is introduced into the slot and is a winding made from conductive, insulated winding wires with prepreg fibers located in between. Since the prepreg impregnating resin is soft and can be plastically deformed, it may be laid into the intermediate spaces of the wires and/or is pushed by the harder wires of the winding to an extent such that, as a rule, no losses in respect of the volumetric degree of filling of the slot with winding wire should be a concern.

Substantially “identical” or different prepreg fibers together with the winding wires can form a conductor. In this case “identical” refers of course to a possible similarity which is realistic in the matter referred to in each case. For example, a cotton fiber is always considered to be “identical” to a cotton fiber of comparable dimension, irrespective of the impregnating resin filling. The prepreg fibers can be identical or different in length, material, diameter, cross-sectional shape and/or arrangement of the fibrils. The prepreg fibers can be identical or different in respect of the content thereof of impregnating resin per volumetric unit of fiber.

The impregnating resin of the prepreg fibers of a conductor can likewise be identical, i.e. made from a standard reaction resin, or different, made of a different reaction resin in each case from prepreg fiber to prepreg fiber. In some embodiments, a mixture of fibers in combination with a mixture of impregnating resin can be used. Mixtures of different prepreg fibers, braided and/or bundled prepreg fibers, or fiber composites can also be used depending on requirements and type of motor.

FIG. 1 shows the prior art with EIS which can be manufactured by dipping conductors in impregnating resin baths. For an overview, FIG. 1 shows, on the left, a housing 1 of a stator with a laminated core 2 and slots 3, and also the respective winding head 4. The detail A of the slot winding is illustrated in enlarged form on the right in FIG. 1.

The individual winding wires which form identically oriented, light strips 5, which are not necessarily parallel, can be seen. This “wild winding” forms comparatively large cavities. According to the example shown here, an optimum packing of the winding wires in the conductor in the slot 3 is not present, and therefore there are the larger cavities, such as, for example, the cavity 7, shown darker, at the bottom on the left. Apart from the light strips which depict the winding wires 5, and the dark strips which show the cavities between the wires that are filled with impregnating resin 7, in this detailed view from FIG. 1 there are also lighter intermediate spaces 6 which are unfilled cavities between the winding wires 5. These cavities 6, like the dipping impregnation according to the prior art, show a wild winding filled only incompletely with impregnating resin.

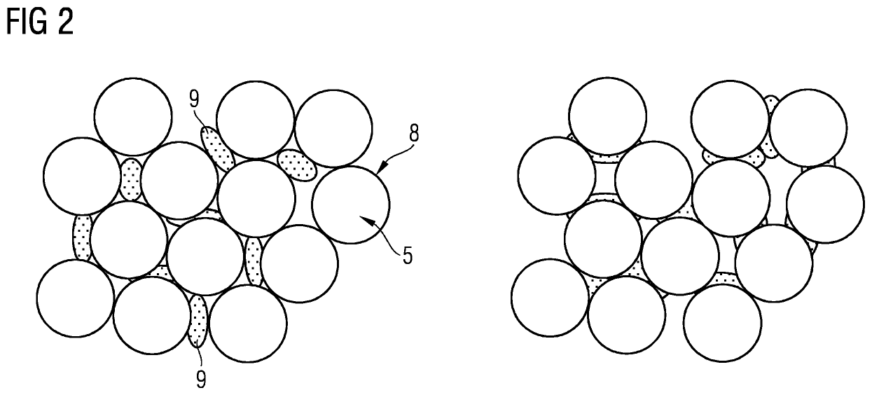

By contrast, FIG. 2 shows a conductor incorporating teachings of the present disclosure in cross section. FIG. 2 shows FIG. 2a on the left and FIG. 2b on the right which follow one another consecutively in the manufacturing process. FIG. 2b also does not show the finished insulation system, but rather only an intermediate stage, in which it can be seen how the prepreg fiber 9 in the winding is deformed during the curing.

In a section through the conductor, in FIG. 2a the light circles are the cross sections of the winding wires 5 which are coated with wire enamel 8, as indicated by the dark edge 8. The prepreg fibers 9 which are provided between the winding wires 5 are placed in a manner so as to be plastically deformable during the winding into the intermediate spaces which are formed by the winding wires 5.

FIG. 2b shows the beginning of the curing of the insulation system according to an exemplary embodiment, wherein it can be seen that the impregnating resin portions of the prepreg fibers 9 melt and are thereby liquefied during the curing. The liquid impregnating resin is distributed and in particular also fills the existing cavities 6 by means of the capillary forces acting in the conductor. During the curing, the impregnating resin is crosslinked and becomes the solid potting compound of wire and carrier. In the finished insulation system, up to 35% by vol, in particular up to 26% by vol, preferably up to 20% by vol of impregnating resin and carrier can then be present in the conductor.

In some embodiments, during the manufacturing of an electric insulation system EIS of an electric motor, the time-consuming and costly dipping impregnating process can be dispensed with without significantly changing the preceding winding process step. There is thus a substantially greater variance in terms of manufacturing, the manufacturing time is reduced and thereby so too are the manufacturing costs.

In some embodiments, the impregnating resin is introduced into the stator as early as during the winding process by means of a carrier medium, such as a carrier fiber. The process step of dipping impregnation is thereby omitted. This is possible by means of the prepreg fiber which introduces a sufficient amount of impregnating resin into the conductor.

The teachings of the present disclosure relate to electric insulation systems of an electric motor, in particular an electric insulation system EIS which is improved in respect of the insulation of the wire winding in the slots of the laminated core from the laminated core, and cost-effective manufacturing processes for manufacturing such an improved electric insulation system of an electric motor. This is achieved by the impregnating resin for forming the casting compound of the conductor being introduced into the conductor in the slot by a carrier medium, such as a fiber.

What is claimed is:

1. An electric insulation system of an electric motor, the system comprising:
a conductor with a wire winding in a slot of a laminated core of a stator of the electric motor;
wherein wires in the conductor are potted by impregnating resin on and in a carrier;
wherein the carrier is loaded with impregnating resin and is arranged between the winding wires in the conductor;
wherein cavities of the conductor are filled with the impregnating resin;
wherein the impregnating resin provides potting for the cavities in the conductor of the laminated core.

2. The insulation system as claimed in claim 1, wherein the carrier comprises prepreg fibers.

3. The insulation system as claimed in claim 2, wherein the prepreg fibers comprise intermingled fibrils.

4. The insulation system as claimed in claim 2, wherein the prepreg fibers comprise plastic fibers.

5. The insulation system as claimed in claim 2, wherein the prepreg fibers comprise glass fibers.

6. The insulation system as claimed in claim 2, wherein the prepreg fibers comprise felts.

7. The insulation system as claimed in claim 2, wherein the prepreg fibers are dimensionally matched.

8. The insulation system as claimed in claim 2, wherein the prepreg fibers comprise a mixture of fibers of different lengths.

9. The insulation system as claimed in claim 2, wherein the prepreg fibers comprise a mixture of fibers of different materials.

10. The insulation system as claimed in claim 1, wherein up to 35% by vol of impregnating resin and carrier are present in the conductor.

11. The insulation system as claimed in claim 2, wherein the conductor comprises volume fractions of prepreg carrier to winding wire at maximum 5% by vol of prepreg fiber to 1% by vol of winding wire.

12. An electric insulation system of an electric motor, the system comprising:
a wire winding as conductor in slots of a laminated core
wherein the wire winding and a carrier in the conductor are embedded in a potting compound;
wherein the potting compound in the conductor is distributed uniformly around the wires and the carrier because the impregnating resin for this purpose is not guided into the conductor from the outside, but rather by means of the carriers which are loaded with impregnating resin in the B state and which remain with the winding wires in the winding.

13. A method for manufacturing an electric insulation system of an electric motor, the method comprising:
winding a conductor including winding wire and impregnating resin carriers;
drawing the conductor into slots of a laminated core of a stator of the electric motor; and
curing the impregnated winding wire/carrier insulation.

14. The process as claimed in claim 13, further comprising, between the drawing-in of the conductor and the curing,
heating up the stator to a temperature at which the prepreg impregnating resin in and on the impregnating resin carrier melts and is uniformly distributed into the adjacent intermediate spaces of the individual winding wires in the slot.

15. The process as claimed in claim 13, wherein the impregnating resin is uniformly distributed between the winding wires of the conductor and within the slot at least partially via capillary forces.
